(19) United States
(12) Patent Application Publication
(10) Pub. No.: US 2011/0109461 A1
(43) Pub. Date: May 12, 2011

(54) TAMPER DETECTION SYSTEM FOR USE WITH PERSONAL MONITORING DEVICES

(76) Inventor: Steve Aninye, Alpharetta, GA (US)

(21) Appl. No.: 12/613,781

(22) Filed: Nov. 6, 2009

(51) Int. Cl. G08B 23/00

(52) U.S. Cl. 340/573.4

(57) ABSTRACT

A tamper-detection system for personal monitoring devices featuring an improved configuration of tamper-detection components uses micro switches to detect movement of the attachment strap and a ratcheting anchor plate with breakable teeth that both allow quick emplacement of the personal monitoring device, and, if broken provide visual evidence of tampering.

### BACKGROUND OF THE INVENTION

Personal monitoring devices are used to monitor the position and movements of individuals of interest. The basic design and principles of operation of the personal monitoring device was disclosed by Schwitzgebel, et. al. in U.S. Pat. No. 3,478,344. Modern personal monitoring devices typically contain at least a position-determining device such as a Global Positioning System (GPS) unit, central processing unit, power supply, and a transceiver. There are a number of differences between early personal monitoring devices such as that disclosed in U.S. Pat. No. 3,478,344 and modern personal monitoring devices. Modern units are much smaller, and integrate the battery pack, position determining device and transceiver in one unit. Modern units also commonly use cellular communications networks instead of dedicated RF frequencies.

Examples of personal monitoring devices include offender-monitoring systems used by law enforcement to monitor parolees, bailees, and persons subject to house arrest. They also include systems used to monitor patients requiring advanced in-patient care and monitoring, such as persons suffering from mental health issues and degenerative neurological diseases like Alzheimer's or dementia, who are often prone to wandering away from the care facility. Mental patients or people suffering from Alzheimer's who have wandered need to be located quickly in order to prevent harm to themselves (i.e. through sustained exposure to the elements) or others. These devices may also be used by parents to monitor the location of their children in public places where they may become separated like amusement parks, malls, or even while walking to school. These devices typically are worn on the ankle or wrist, and contain tamper-detection features that generate alerts when the devices are removed.

In all these cases, it is desirable to have some form of tamper-detection system in place. Law enforcement needs to be alerted quickly if a monitored offender removes the monitoring device, since this may indicate that the offender is preparing to engage in criminal activity. Similarly, patients who intentionally or unwittingly remove their monitoring devices may wander away from their care facility or home unnoticed, so caregivers need to be quickly alerted if the monitoring device is removed. Finally, if a child's monitoring device is removed, this can be a sign that the child has been abducted. In this case, a tamper-detection system that generates an alert is also very desirable.

Schwitzgebel, Layson Jr., et.al. (U.S. Pat. No. 5,959,533), Jennings (U.S. Pat. No. 5,612,675) and Galperin (U.S. Pat. No. 7,064,670) all disclose the use of tamper-detection circuits that send a tamper alert when a signal contained in a signal-carrying means embedded in the attaching strap is interrupted when the strap attaching the monitoring unit is cut. The signal-carrying means can be either wire or fiber-optic cable.

One problem with the prior art tamper-detection systems is that they must be custom-fitted with special tools. Straps containing the signal-carrying means have a fixed end and a free end. As disclosed in Layson, the free end of the strap must be cut so that the strap fits snugly around the subject's limb (e.g. arm/wrist or leg/ankle) and then inserted into a fastening means such as a screw or strap clamps. In Layson, the strap clamps holding the free end additionally act to electrically connect the transmitter electronic circuit board to the antenna built into the strap. Galperin discloses two straps, the free ends of which are joined by a mechanically and electrically-connecting and locking means.

The arrangements described above have a couple of key disadvantages. First, affixing a position monitoring device to a subject requires at least a cutting tool and a tool to operate the fastening means on the device. It is therefore desirable to have an attaching strap that can be quickly and easily attached and customized without having to use special tools. Second, the electrical connection at the strap clamp is more susceptible to the intrusion of foreign substances such as water or dirt, either which have the potential of shorting out the connection. The person installing the strap must take great care to ensure that the junction of the free end of the strap with the fastening means is kept waterproof and free of dirt.

Jennings, et.al. discloses one possible solution. In Jennings, the free end of the attachment strap is inserted into a channel until the apertures in the strap line up with a spring-loaded piston which holds the strap in place. Thus, the strap disclosed in Jennings can be adjusted relatively easily for the size of the subject's limb. However, the disadvantage of Jennings is that it is still relatively complex, requiring a locking pin and a gear shaft to be engaged in order for the tamper-proofing system to be armed.

### BRIEF SUMMARY OF THE INVENTION

The tamper detection system described herein features a strap that can be fitted to the subject's limb size without special tools. The free end is simply passed through a locking means defining a channel between it and the lower body of the position monitoring device. This locking means is comprised of teeth mounted on flexible tabs that ratchetably engage holes in the strap, permitting the strap to be tightened but not loosened. In the event the strap is loosened, the locking mechanism's teeth are specially designed to break when a force exceeding a given threshold is exceeded. Once the teeth are broken, the device cannot be reattached properly, giving obvious visual evidence of tampering.

Working in conjunction with the locking means is a micro switch that engages specially-shaped notches on one or both edges of the attachment strap and is actuated by when the wearer moves the strap relative to the micro switch (e.g. by attempting to remove the strap).

Thus, the present invention allows personal monitoring devices to be easily attached because special tools are not required to adjust the size of the attaching strap to the wearer. The present invention also more reliably detects tampering because of redundant tamper-detection elements. The result is that even if one tamper detection element is defeated, the redundant element will detect the tampering.

### BRIEF DESCRIPTION OF THE DRAWINGS

FIG. 1 shows the tamper-detection system described herein.

FIG. 3 is a detailed view of the strap of the tamper-detection system described herein, along with the signal-generating means.

FIG. 4 is a side view of the internal configuration of the tamper-detection system described herein, including the mass-detection means, locking means, and micro switch.

FIG. 5 is a front view of the tamper-detection system.

FIG. 6 is a detailed view of the locking means.

FIG. 7 shows an exploded isometric view of the tamper-detection system.

### DETAILED DESCRIPTION OF THE INVENTION

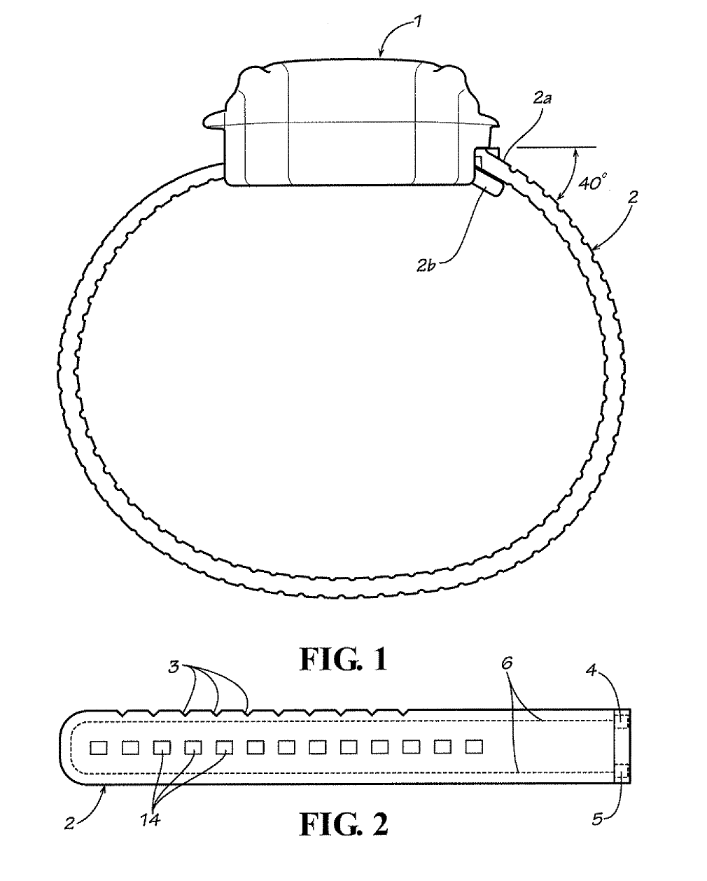

The tamper-detection system described herein is designed to be used in conjunction with the full range of personal monitoring devices worn by human subjects. FIG. 1 shows a side exterior view of the one embodiment of applicant's personal monitoring device. Body 1 contains a position-determining device such as a Global Positioning System (GPS) unit, power supply, and a transceiver. Strap 2 has a fixed end 2a that is rigidly connected to body 1. It was found that attaching the fixed end 2a at an angle of approximately 40 degrees below horizontal body axis of body 1 (as shown in FIG. 1) is ergonomically desirable, and also reduces stress substantially at the mounting point, thereby increasing strap life.

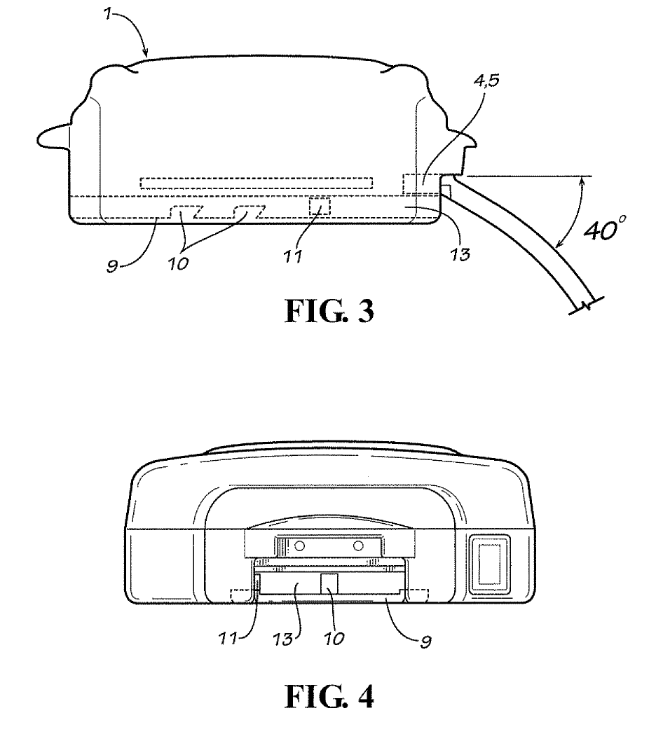

FIG. 2 shows the internal configuration of strap 2. Fixed end 2a abuts a signal generator 4 and a signal receiver 5. As shown in FIG. 2, strap 2 contains an embedded signal carrying means 6 disposed within strap 2 in an elongated U-shape similar to that disclosed in Jennings, although the contemplated embodiment uses a fiber optic cable instead of an electrical conductor, although any means of carrying a signal known to the art (i.e. waveguide, soundwave conductor, etc.) could be used. This allows the signal generator 4 and signal receiver 5 to be located side by side at the fixed end of the strap. Also shown in FIG. 3 are notches 3 in the edge of strap 2. Although FIG. 2 only shows notches 3 in one edge of strap 2, it should be understood that both edges of strap 2 may be notched if desired.

FIG. 3 is a view of the internal configuration of the personal monitoring device, showing the claimed tamper-detection features. As shown in FIGS. 1 and 3, Strap 2 is attached at its fixed end 2a to body 1. In order to install the personal monitoring device, the free end 2b of strap 2 passes through a channel 13 whose top and bottom are defined by the base of body 1 and locking means 9, respectively, and whose sides are defined by the base of body 1, as shown in FIGS. 3, 4 and 6. As shown in FIG. 1, strap 2 does not have to be custom-fitted to the size of the wearer's limb; the free end 2b passes through the channel and any excess length is disposed under strap 2. No special tools are therefore required to fit the strap to the size of the subject's limb, making it very easy to emplace the personal monitoring device. To fit the device to a subject, strap 2 is simply wrapped around the subject's limb, free end 2b is inserted into channel 13 and the strap is pushed or pulled through the channel through locking means 9 until the desired fit is achieved.

Micro switch 11 shown in FIGS. 3 and 7 is located in the wall of channel 13. The actuator button of the micro switch is shaped so that it engages the notches 3 in strap 2 shown in FIG. 7. The micro switch is attached to an arming mechanism which is reset by monitoring personnel once the personal monitoring device has been fitted to the wearer. Once armed, any linear movement of the strap within the channel exceeding a threshold distance predetermined by the size of notches 3 will actuate the micro switch, generating an alarm signal.

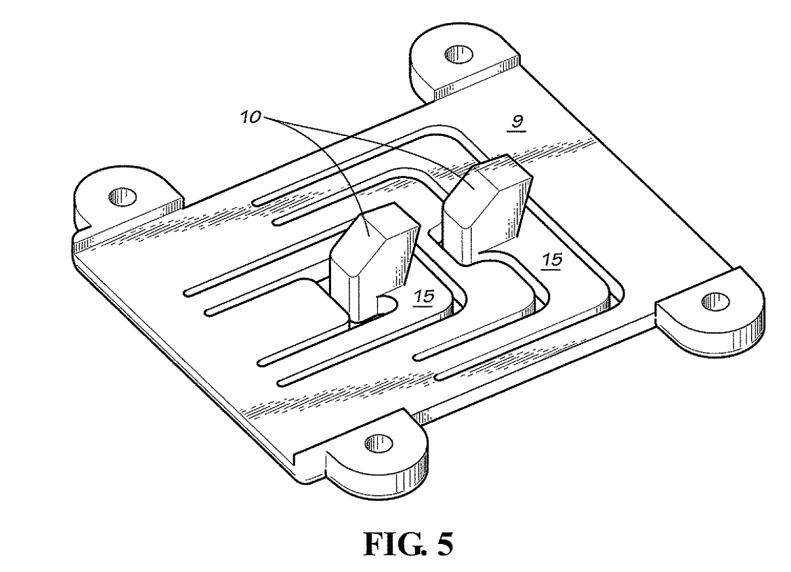

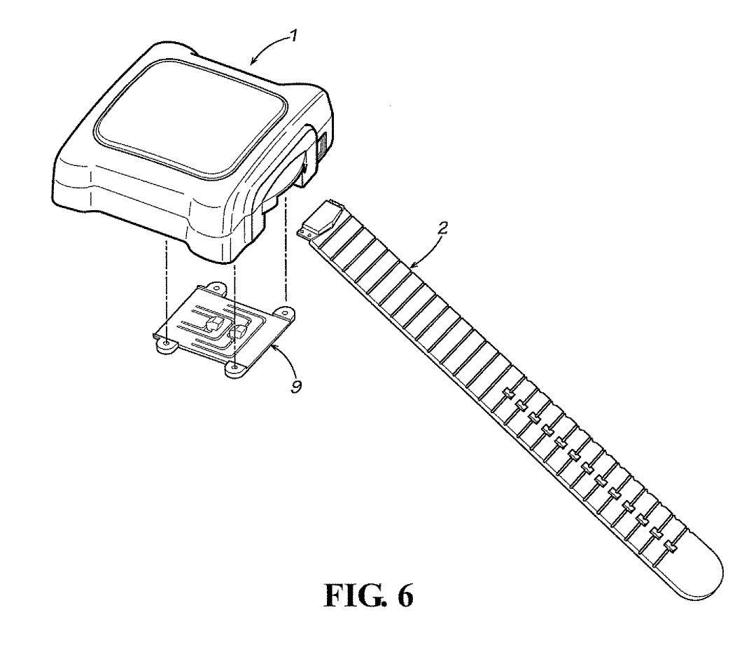

FIG. 5 is a detailed view of locking means 9 showing teeth 10. Locking means 9 is made from a suitable grade of injection-molded plastic. Teeth 10 engage holes 14 in strap 2. The base of teeth 10 are integral to and attached to the locking means 9 by way of flexible tabs 15. Because of the flexibility of tabs 15 and their shape, teeth 10 ratchetably engage holes 14 in strap 2, allowing the strap to pass freely through channel 13 in one direction only. However, flexible tabs 15 are designed to break when force exceeding a predetermined threshold is exceeded in the opposite direction, that is, when the subject tries to loosen or pull the strap out. A force of 50-80 lbs is a typical threshold force that will cause the teeth to break. As shown in FIG. 6, locking means 9 and strap 2 are attached to the bottom of body 1. Locking means 9 is designed to be attached to the bottom of body 1 by screws or any suitable fastener known to the art that cannot be easily removed.

This configuration serves a dual purpose. First, it allows the strap to be easily adjusted to the size of the subject's limb. Second, it provides tamper-detection redundancy because the tabs, once broken, provide clear visual evidence to monitoring personnel that the personal monitoring device has been removed.

The simplicity of the tamper-detection system described above results in lower cost and reliability relative to the more complex methods disclosed by the prior art.

The foregoing examples and embodiments should be construed as explanatory in nature and should in no way limit the scope of the present invention. Words used in the foregoing paragraphs are thus words of description and illustration, not limitation. Although the present invention has been described herein with reference to specific means, materials, and embodiments, the present invention is not intended to be limited to the particulars disclosed herein; rather, the present invention extends to all functionally-equivalent structures, methods, and uses as are within the scope of the appended claims.

What is claimed is:

1. A tamper-detection system for use with personal monitoring devices comprising:
at least one strap comprising a fixed end, a free end, signal-carrying means, said strap having a plurality of holes therein
at least one micro switch;
locking means;
wherein at least one edge of said strap is shaped to conformably engage said micro switch, said free end being constrained to move in a first direction and a second direction in the vicinity of said micro switch such that said micro switch when actuated generates an alarm signal when said strap is moved in a first direction relative to said micro switch and wherein said locking means comprises at least one breakable locking tooth engaging at least one of said holes in said strap.

2. A tamper-detection system for use with personal monitoring devices comprising:
at least one strap comprising a fixed end, a free end, and a plurality of holes;
locking means having at least one breakable locking tooth ratchetably engaging at least one of said holes,
wherein said strap is constrained to move in a first direction and a second direction in the vicinity of said locking means, and where said breakable locking tooth will break when a force exceeding a predetermined threshold is applied in said first direction.

3. The tamper-detection system of claim 2, further comprising at least one micro switch, wherein at least one edge of said strap is shaped to conformably engage said micro switch so that movement of said strap actuates said micro switch, thereby generating an alarm signal.

4. The tamper-detection system of claim 3, wherein said fixed end is affixed to the body of said personal monitoring device at an attachment angle of about 40 degrees.

5. A tamper-detection system for use with personal monitoring devices comprising:
at least one strap comprising a fixed end, a free end, and a plurality of holes; and
at least one micro switch,
wherein at least one edge of said strap is shaped to conformably engage said micro switch so that movement of said strap actuates said micro switch, thereby generating an alarm signal.

6. The tamper-detection system of claim 5, further comprising a locking means having at least one breakable locking tooth ratchetably engaging at least one of said holes,

7. The tamper-detection system of claim 6, wherein said fixed end is affixed to the body of said personal monitoring device at an attachment angle of about 40 degrees.
